(19) United States
(12) Patent Application Publication
(10) Pub. No.: US 2010/0263597 A1
(43) Pub. Date: Oct. 21, 2010

(54) HAY FEEDER

(76) Inventor: James P. Kerns, North Bloomfield, OH (US)

Correspondence Address: D.A. Stauffer Patent Services LLC, 1006 Montford Rd., Cleveland Hts., OH, 44121-2016, US

(21) Appl. No.: 12/729,232

(22) Filed: Mar. 22, 2010

Related U.S. Application Data
(60) Provisional application No. 61/162,243, filed on Mar. 20, 2009.

(51) Int. Cl. A01K 1/10

(52) U.S. Cl. 119/60

(57) ABSTRACT

A feeder of hay-like livestock feed including types of feed being provided as, or mixed in with one or more of straw, grass-like plant stems, grains and shafted grains; the feeder comprising: a hay holding cage that has a gridwork of horizontal as well as vertical bars that create openings sized to limit livestock to pulling out only a mouthful of hay at a time, thereby reducing wasted hay dropped on the ground, wherein opening is 1 to 2.5 inches larger than muzzle dimensions for the animals to be fed, a skirt rail at a height matching a toe to brisket dimension of cattle; a top opening sized for length of bale, and bottom of grid spaced to get about 32″ from cage side to outside of top skirt rail=average brisket to muzzle/nose dimension for cattle an inverted pyramid-like funnel with four sides (gridwork on all 4 if square/equal-sided pyr); or (long rectangular cage is V trough with flat vertical ends covered by panels, and four corner legs supporting top of cage.

### CROSS-REFERENCE TO RELATED APPLICATIONS

This application claims the benefit of U.S. Provisional Patent Application No. 61/162,243, filed Mar. 20, 2009 by James P. Kerns.

### TECHNICAL FIELD OF THE INVENTION

The present invention relates to animal husbandry, feeding devices and, more particularly to racks and troughs for animal feeding.

### BACKGROUND OF THE INVENTION

The present inventor runs a farm with livestock of various sizes from small (e.g., goats) to large cattle, including some having horns, even longhorns. The livestock are fed hay (a term used generically herein to include all types of feed being provided as, or mixed in with, straw or grass-like plant stems and/or grains and/or shafted grains).

Historically the evolution of livestock feeding methods (other than grazing) progressed from “hay” spread on the ground, to use of a manger or trough to raise the hay above ground level to prevent contamination and rapid spoiling caused by moisture, animal excrement, mud, and animals walking or resting upon it, all of which cause waste due to the animal not being willing to eat degraded feed such as that.

Another stage of evolution is a feed rack designed to hold a larger quantity of hay in a vertically stacked orientation. Since the animals can no longer reach the top of the pile, the rack is made with various provisions for releasing the hay from the bottom and/or sides of the rack. For example, a rack made of crossed sticks in an X or V configuration that is held together in a row of spaced apart parallel X or V crosses. From such a feeding rack, the animals can pull out bites of hay through the spaces between the vertical sticks (slats). Any more than a mouthful of hay that is pulled out will drop down below the rack, where the animals may pick it up for eating if it isn't degraded by ground contact or moisture accumulation and spoiling, and the like. This type of feed rack is linear and allows feeding from one or two long sides.

Another stage of evolution is disclosed, for example, in U.S. Pat. No. 0,310,261 (W. S. Downing; Jan. 6, 1885), which describes a combined feed rack and manger comprising a rack having a four, equal length sided, inverted truncated pyramid construction using spaced apart vertically extending slats fastened in place by a square frame of horizontal cross pieces at the top and the bottom ends of the slats. The top frame is supported by four vertical corner posts, which are also attached to a solid horizontal “floor” at the level of the bottom frame which is attached to the floor in the center. Siding planks are attached around the posts and to the floor, the planks extending upward therefrom. At the top edge of the siding an outward-flaring top or rim is fastened. The siding and floor thus provide a manger to catch hay that is dropped while the animals are feeding from the rack.

Most recently, hay feeders have evolved further in order to hold present day bales of hay that can be quite large and heavy. For example, U.S. Pat. No. 6,672,247 (T. L. Lienemann; Jan. 6, 2004) presents a typical (present day) prior art feeder as: a conventional livestock feeder which is used to feed cylindrical hay bales placed therein to livestock. The bale feeders of the prior art are generally cylindrical or round and include a lower ring-shaped frame member, an intermediate ring-shaped frame member, and an upper ring-shaped frame member. In some feeders, the intermediate ring-shaped frame member is omitted. In many prior art feeders, a plurality of horizontally spaced-apart bars or pipes are welded to and extend between the frame members.

The bars are normally covered or enclosed by a shield which is secured to the lower and intermediate frame members which extends therebetween to prevent hay from passing outwardly through the bars near the ground. A plurality of spaced-apart bars or pipes are welded to and extend between the intermediate and upper frame members in conventional fashion. Normally, the bars are angularly disposed. The pipes are sufficiently spaced-apart to permit the animal to insert its head between the bars while preventing the animal from entering the interior of the feeder. Normally, cylindrical hay bales are placed in the interior of the feeder. The animal extends its head and neck between the bars to feed. In the feeding process, much hay falls or is pulled outwardly through the bars and falls upon the ground wherein it is trampled, resulting in hay waste. Additionally, the hay in the feeder rests upon the ground which may lead to spoilage of the hay which is in contact with the ground within the feeder.

In combination with a prior art feeder, Lienemann's '247 patent discloses a hay saver insert as an inverted circular cone below a vertical shield around the open top of the cone. The cone sides are made of upwardly and outwardly extending spaced apart bars held from spreading by top and bottom plus an intermediate ring shaped frame members. The disclosed insert is designed to be supported by the prior art ring shaped circular bale feeder such that the conical shaped portion of the insert extends downward within the prior art feeder with the lowermost bottom ring shaped frame member being held above ground level. Construction is disclosed as being like the prior art feeder with tubular metal “bars or pipes” and welded joints.

Thus the recent prior art hay feeders present hay to the livestock in a feeder designed to hold a large amount of hay, typically in one or more bales—either round or rectangular/square —and to hold the hay in a somewhat vertical arrangement with substantially vertical openings in the feeder's frame through which the livestock can pull out hay to eat.

The prior art commonly in use now is a cage of vertical metal bars (e.g., steel tubing) bolted or welded to circumferential frame rings (top and bottom, maybe also in middle) to produce an open topped cage for containing one or more bales of hay. Many feeders are open at the bottom also, such that the hay bales rest on the ground where it can spoil. Other feeders attempt to address this problem by making the hay cage in an inverted (possibly truncated) conical or pyramidal “funnel” shape. To support the funnel type of hay cage, a surrounding frame of supports is added, and typically a large number of spaced apart supports are used to additionally restrict access to the hay to a limited number of animals at any one time.

Especially for the funnel type of hay cages, the hay feeders must be provided in several different sizes to accommodate short versus tall livestock.

As an animal eats from the feeder, it typically pulls out as large a mouthful as possible and then backs away enough to chew it—resulting in a significant amount of the hay falling onto the ground where it can be trampled and thus wasted. This problem is made worse when shorter straw lengths are used in the bale, because hay nearby the mouthful being pulled out will follow through the cage bars and drop down uneaten. Using a funnel type hay cage and placing a skirt around the bottom of the vertical cage supports prevents the trampling of hay that drops within the confines of the skirt, but doesn't prevent it from landing on the ground within the skirt where, if not picked up by the animals, it can quickly spoil on wet and/or muddy ground.

Prior to this invention, the inventor observed waste that was well over 50 percent of a bale. At $30-$45 for a 4×4 round bale of good timothy this is a huge waste of money.

In order to make more efficient use of the farmer's work effort, the hay bales are being made in ever larger sizes so that they won't need re-loading as often, providing that the hay feeder is large enough to contain it and to support its weight. The newest bale now available is rectangular 3 feet by 4 feet by 8 feet (3′×4′×8′) and weighs 1200 to 1400 pounds. The prior art feeders are not able to make efficient use of such a large bale, and many aren't able to support its weight or even to fit it in.

Vertical spaced-apart bars/supports around the feeder periphery cause problems if not spaced specifically for a given size of livestock, and even then is a problem for horned cattle which are coming back into fashion for the leaner qualities of the meat. In addition, the restricted access increases the chance of injury to stock from animals pushing and shoving in competition for food. Injury is also caused by bumping against a sharp-edged skirt.

Construction of prior art feeders is typically welded or bolted-together steel tubing (e.g., 14 to 16 gauge walls) which is easily damaged by large cattle. Many feeders are simply crushed by large bulls pushing them around.

With revenue constantly under downward pressure, the livestock farmer must cut costs wherever possible in order to survive. There is a great need, so far unaddressed, to reduce costs by significantly reducing waste of hay (feed), reducing injury to livestock, improving efficiency of the farmer's work time, and reducing equipment purchase and maintenance costs.

Therefor it is an object of the present invention to provide an improved hay feeder that addresses the deficiencies of prior art feeders as described hereinabove.

### BRIEF SUMMARY OF THE INVENTION

According to the invention a feeder is disclosed of hay-like livestock feed including types of feed being provided as, or mixed in with one or more of straw, grass-like plant stems, grains and shafted grains; the feeder comprising: a hay holding cage that has a gridwork of horizontal as well as vertical bars that create openings sized to limit livestock to pulling out only a mouthful of hay at a time, thereby reducing wasted hay dropped on the ground, wherein opening is 1 to 2.5 inches larger than muzzle dimensions for the animals to be fed, a skirt rail at a height matching a toe to brisket dimension of cattle; a top opening sized for length of bale, and bottom of grid spaced to get about 32″ from cage side to outside of top skirt rail=average brisket to muzzle/nose dimension for cattle an inverted pyramid-like funnel with four sides (gridwork on all 4 if square/equal-sided pyramid); or long rectangular cage is V trough with flat vertical ends covered by panels, and four corner legs supporting top of cage.

Other features include:

A design that is modular to ease transport, particularly for larger models, and also to make it adaptable to an individual farmer's needs (present and future).

A feeder that reduces waste of feed (hay) as much as possible (the present design has reduced waste to less than 10 percent in private tests.)

A feeder that is safe for all livestock species and age ranges, comfortable for their use

Feeder is easy to load, and is shaped and sized to accommodate multiple bales in some cases.

Allows easy use by horned cattle.

An open design, with a minimum of vertical spacers or access restricting bars, reduces the chance of injury to stock from animals pushing and shoving in competition for food, and doesn't catch long horns.

Built very heavy duty to take the abuse that large bulls will dish out without failing.

Modular to ship flat on a pallet and be easily assembled at the retailer or end user location, something prior art feeders don't do.

square feeder is built to accept all sizes of round bales.

rectangular feeder is a new style of feeder specifically designed to accept one or more of the new 1200-1400 pound “square” bale (3′×4′×8′).

Grid dimensions adjusted to muzzle/nose dimensions (squared off)+˜35% to get right bite size without pulling out too much.—avg cattle=5″W×6″H→7″W×8″H grid opening. Alternative, preferred, is add approximately 1 to 2.5 inches to the muzzle dimensions. Tighter needed for aggressive eaters like cattle.

75″×75″ open top (OD) for round bales
only the four corner support legs, without intermediate upward extending separator bars
adjustable corner leg height using overlapping lengths of angle iron (and bolts thru selected hole pairs)
height of cage at top is adjusted for size animals: 5-6.5 feet high
truncated pyramid tip 12″ across opening at bottom edge of cage

tip is raised above ground

manger floor above ground, below tip, is perforated for water drainage and aeration

expanded metal, flat top surface (prevent injury)

skirt rail(s) provided around bottom portion of feeder

height adjusted for animal height toe-to-brisket: 18″ used for cattle (avg 20″, range 14-27″ across age range)

lower skirt is added=sheet metal between top and bottom skirt rails
top panel is added to hold more hay (18″ to get 6.5 foot loading height on cattle size feeder)

Other objects, features and advantages of the invention will become apparent in light of the following description thereof

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 9 may be referred to individually as 9a,9b,9c, etc. Or, related but modified elements may have the same number but are distinguished by primes. For example, 9,9′, and 9″ are three different elements which are similar or related in some way, but have significant modifications. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is a perspective view of a “square” feeder embodiment, according to the invention.

FIG. 2 is a top view of the square feeder embodiment of FIG. 1, according to the invention.

FIG. 3 is a perspective view of a “rectangular” feeder embodiment, according to the invention.

FIG. 4 is a bottom view of a manger (catch tray) portion of a feeder, according to the invention.

FIG. 5 is an end view of the rectangular feeder embodiment of FIG. 3, wherein the end panels are illustrated as if they were transparent to show the result of stacking multiple large rectangular bales in the hay feeder, according to the invention.

FIG. 6 is a side view of a grid portion of the square feeder embodiment of FIG. 1, according to the invention.

FIG. 7 is a side view of the square feeder embodiment of FIG. 1, according to the invention.

FIG. 8 is a side view of a grid portion of the rectangular feeder embodiment of FIG. 3, according to the invention.

FIG. 9 is a top view of the rectangular feeder embodiment of FIG. 3, according to the invention.

FIG. 10 is a side view of the rectangular feeder embodiment of FIG. 3, according to the invention.

FIG. 11 is a side view of a leg portion of a feeder, according to the invention.

FIG. 11A is a bottom view of a foot portion of the leg of FIG. 11, according to the invention.

FIG. 11B is a top view of a post portion of the leg of FIG. 11, according to the invention.

FIG. 12 is a side view of a two-part telescoping corner support post for adjustable feeder height, according to the invention.

FIGS. 13 and 14 are perspective views of a round bale and a rectangular bale, respectively, for use in hay feeding according to the invention.

FIG. 15 is a perspective view of a feeder in use by large and small cattle, showing feeder parts and dimensions relative to dimensions of the cattle bodies, according to the invention.

FIG. 16 is a front view of an animal muzzle showing overall dimensions that are related to feeder parts and dimensions, according to the invention.

FIG. 17 is a perspective view of a small animal feeder embodiment, according to the invention.

FIG. 18 is a perspective view of a deer and elk feeder embodiment, showing a grid portion that is shaped to avoid damage to antlers, according to the invention.

FIG. 19 shows a side view of a rain cover added on the square feeder embodiment of FIG. 1, wherein the cover is shown closed and dashed lines show the cover opened, according to the invention.

### DETAILED DESCRIPTION OF THE INVENTION

### Summary of Features and Aspects of the Invention

The inventive improved hay feeder includes a hay holding cage that has a gridwork of horizontal as well as vertical bars that create openings sized to limit livestock to pulling out only a mouthful of hay at a time, thereby reducing wasted hay dropped on the ground. An optimum opening size is a rectangle that is about 7 to 8 inches on a side. Openings can be increased to as much as 10 inches square for the largest animals, and can be correspondingly reduced for small animals who have small muzzles, although reduced size isn't too important since the smaller animals are not able to grab too large a mouthful anyway. The rectangular shape is not required versus other geometries (e.g., circle, octagon, etc.) but is the simplest format for a grid and thus is preferred.

A first preferred embodiment is the square feeder 100 wherein the shape of a hay cage 102 is an inverted pyramid-like funnel with four gridwork sides 104 and a truncated bottom 112. Although square in top view, it is also referred to as a “round” feeder because it works so well with a round (cylindrical) hay bale 910.

A second preferred embodiment is a “rectangular feeder” 200 for the new 3′×4′×8′ (foot) rectangular bale, the hay cage 202 having a trough-like funnel shape with two opposed slanted gridwork sides 204 along the length, and vertical blank walls 205 at the two ends.

Dimensioned and sturdily constructed to hold even the largest new types of bales.

Heavy gauge angle iron used for support structure sturdy enough for extended life with large livestock. Four corner support posts 118 enable open access even for horned cattle—no separator bars.

Welded cage gridwork sides, but otherwise predominantly heavy-duty bolted construction as needed to allow flat shipping of unassembled feeder; and to enable separate purchase and customized use of modular elements.

Modular elements include: approach-controlling bottom skirt 124 and rails 120, 122; optional two-part telescoping corner support posts 118′ allowing height adjustment as well as optional bottom support; or interchangeable support posts 118 available in at least “short” and “tall” sizes; or multiple holes in a tall corner post 118 such that the top panel 130 and grid 104 top edge 114 can be bolted on at selectable heights; and grid sides 104 that are shipped separately as flat pieces, but are assembled with bolts B along the sloped side edges 116 (see FIG. 2).

The adjustable corner post 118′ (see FIG. 12) has a top portion 132, and a bottom portion 134 that overlap and each has a series of holes H for bolts B that align at different selectable heights - e.g., hole H1 aligned with H11 makes the shortest height, and H3 with H11 makes the tallest.

A manger or catch tray 138, 338 is made of perforated metal such as, preferably, expanded metal sheets 142 that are mounted in a frame 140 and bolted to the corner support posts 118 and/or skirt rails 122 or panels 124 such that it is raised off the ground to keep dropped hay dry, aerated, and clean without holding rain water. The dropped hay is also elevated so that the livestock are more likely to see it and eat it. Injury to lips is prevented by using metal that has at least the top surface 144, 344 flat and as smooth as possible.

Details and Notes

The present invention is the result of a long and serious effort by a knowledgeable livestock farmer to design a better hay feeder, based on needs he identified in his own use of hay feeders. Various features were identified that would solve problems as well as improve convenience.

Dimensions given herein are exemplary and not limiting (unless specifically stated to be limiting), but these are recommended dimensions for best mode implementation.

The most important dimension is the bounds of the gridwork openings 110, 310, 410 in the hay cages 102, 202, 302, 402. As noted in the summary above, ideally the openings are square or rectangular and sized between about 5 and about 10 inches on a side. Most preferably, the optimum for cattle is about 7″ wide W by 8″ high H. For small animals, a 5×5″ opening works well. As can be seen from the drawings, angled gridwork ends such as the pyramid edges do not allow for rectangular openings along those edges, in which case a compromise is struck between not-too-large (lots of hay falls out) and not-too-small (inaccessible to the animal's muzzle). Obviously those irregular openings will be non-optimum.

Referring to FIG. 15, dimensions such as many of the heights are considered ergonomically optimum for general livestock feeding. For example, the skirt 124 or skirt rail 120 is about 18 inches high rather than the typical prior art skirt at 24-28 inches. This height better accommodates the large chests of big cattle, and is matched to an average toe to brisket dimension TB measured between 14″ to 27″ across age ranges of cattle.

Similarly, the average brisket to muzzle dimension BM is used to limit the distance from the skirt rail 120 to the side of the cage 102, 202. This measurement averages 32 inches for cattle.

Due to modular design, the lower skirt 124, rails 120, 122 and tray 138 can be removed so that really small animals can stand under the hay cage 102, 202, 302, 402 to feed. Or the skirt 124 can be replaced by a skirt rail 120 that may be less injurious to forelegs and/or would be stronger than a sheet metal skirt. Preferably, however, the sheet metal is reinforced by angle iron bars.

Structural steel is used wherever possible. For example, the corner posts (supports, legs) may be 3″×3″×0.25″ angle stock.

Grid 104, 204, 304, 404 dimensions are adjusted to muzzle/nose dimensions (squared off) MW×MH+about 35% to get right bite size without pulling out too much.—average cattle=5″MW×6″MH→7″W×8″ H grid opening 110, 310, 410. An alternative, preferred calculation is to add approximately 1 to 2.5 inches to the muzzle dimensions. Tighter needed for aggressive eaters like cattle.

75″×75″ open top TL×TW dimensions for round bales
only the four corner support legs, without intermediate upward extending separator bars
height of cage 102 at top edge 114 is adjusted for size animals: 5 to 6.5 feet high
truncated pyramid tip 12″ across opening at bottom edge of cage

tip is raised above ground

manger floor 138 is above ground, below cage bottom 112, is perforated for water drainage and aeration-Use expanded metal, flat top surface (prevent injury)
upper panel 130 is added to hold more hay (top panel height TPH is 18″ to get 6.5 foot loading height on cattle size feeder with PH post height of 5 feet.)

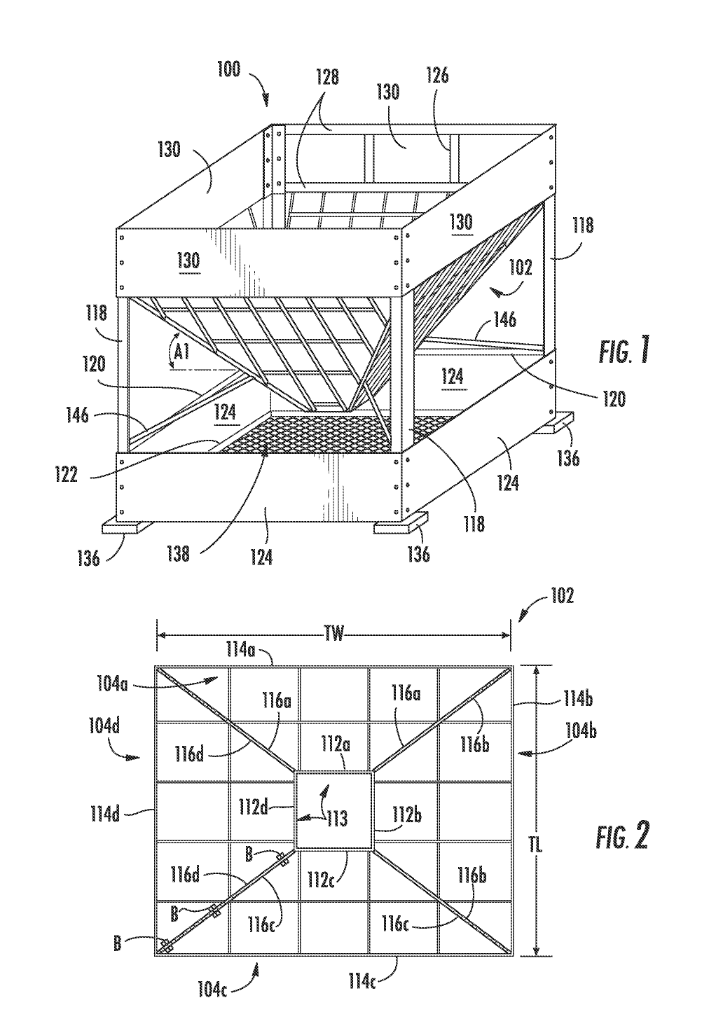

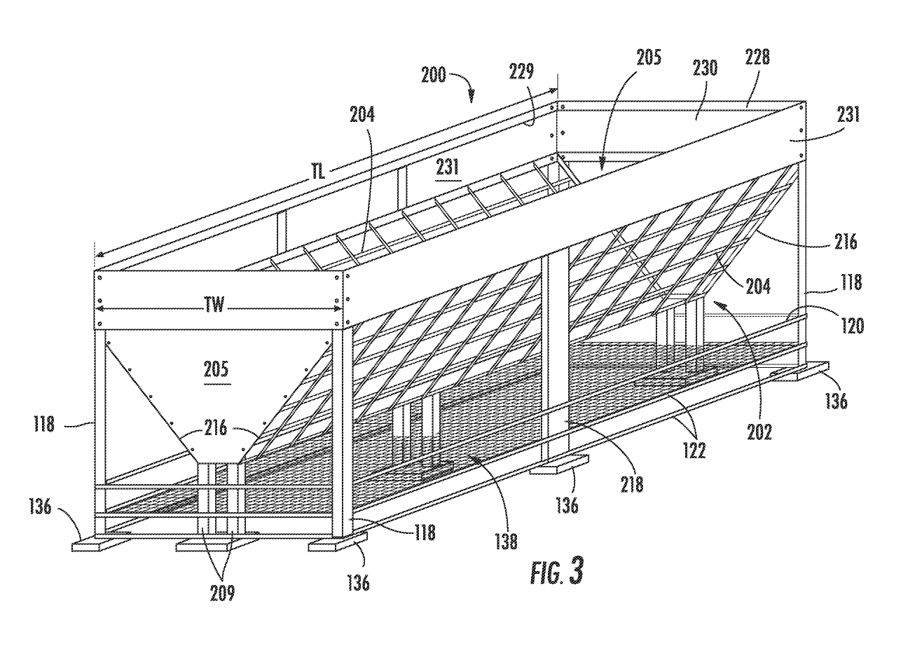

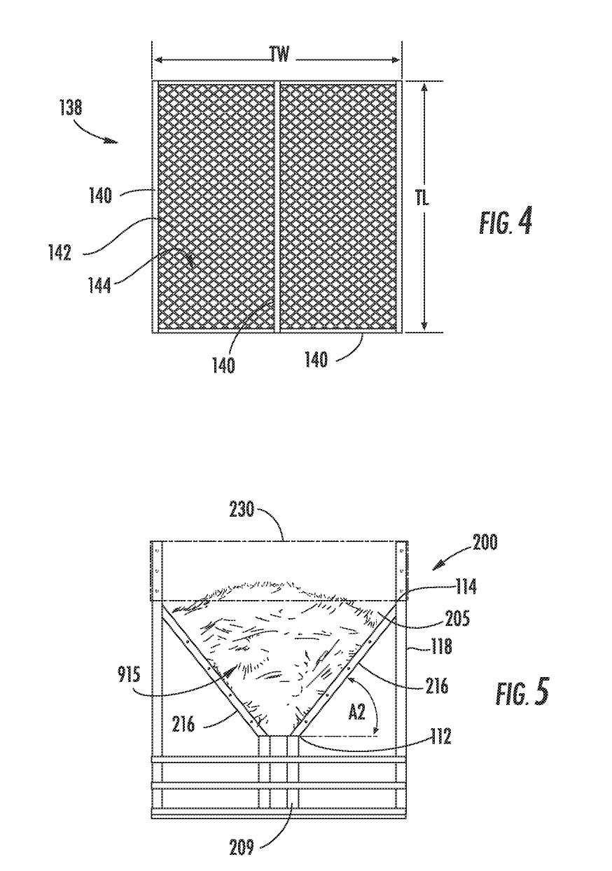

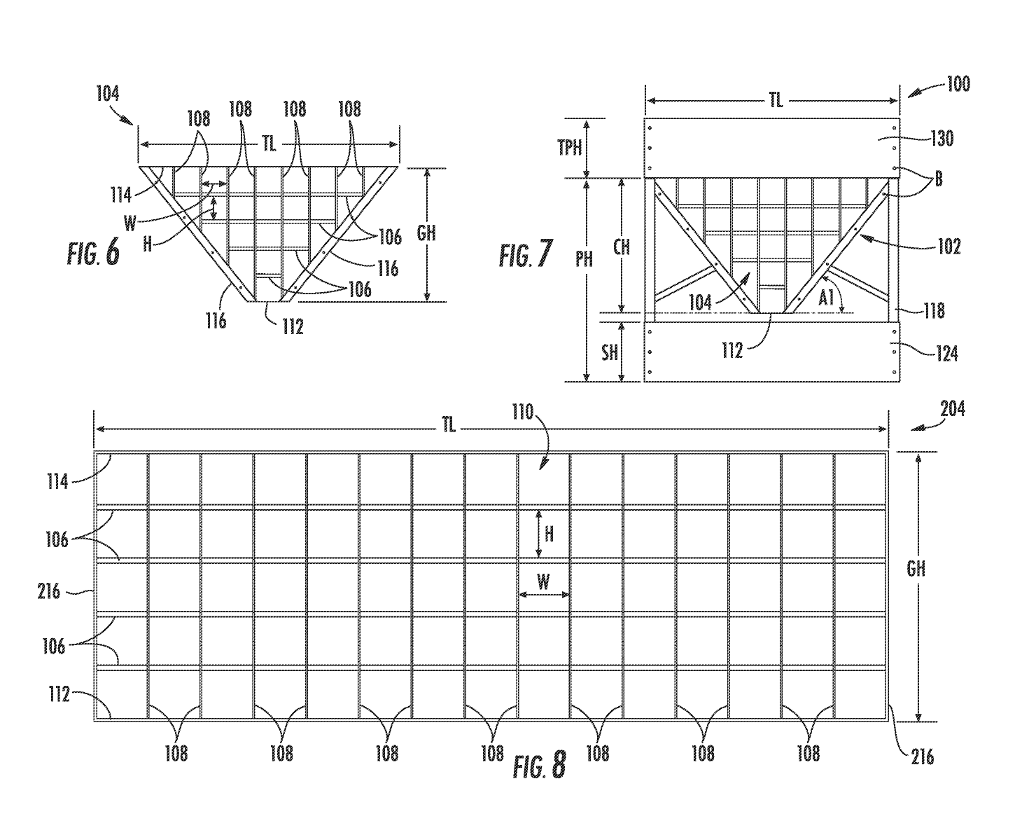

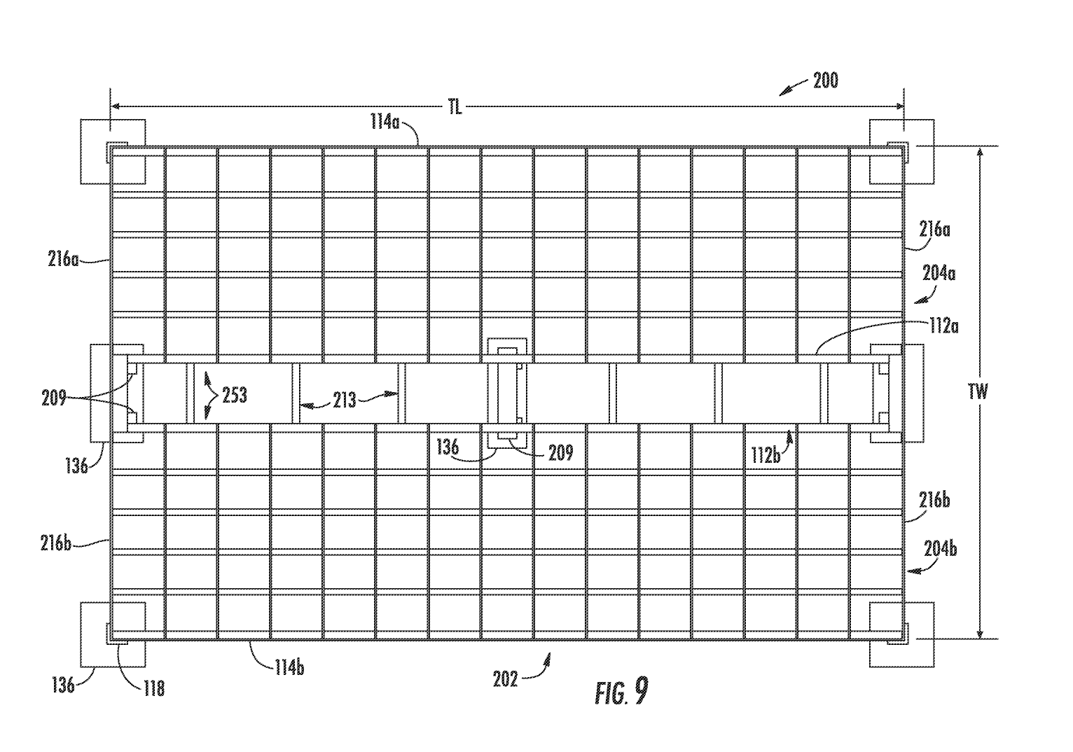

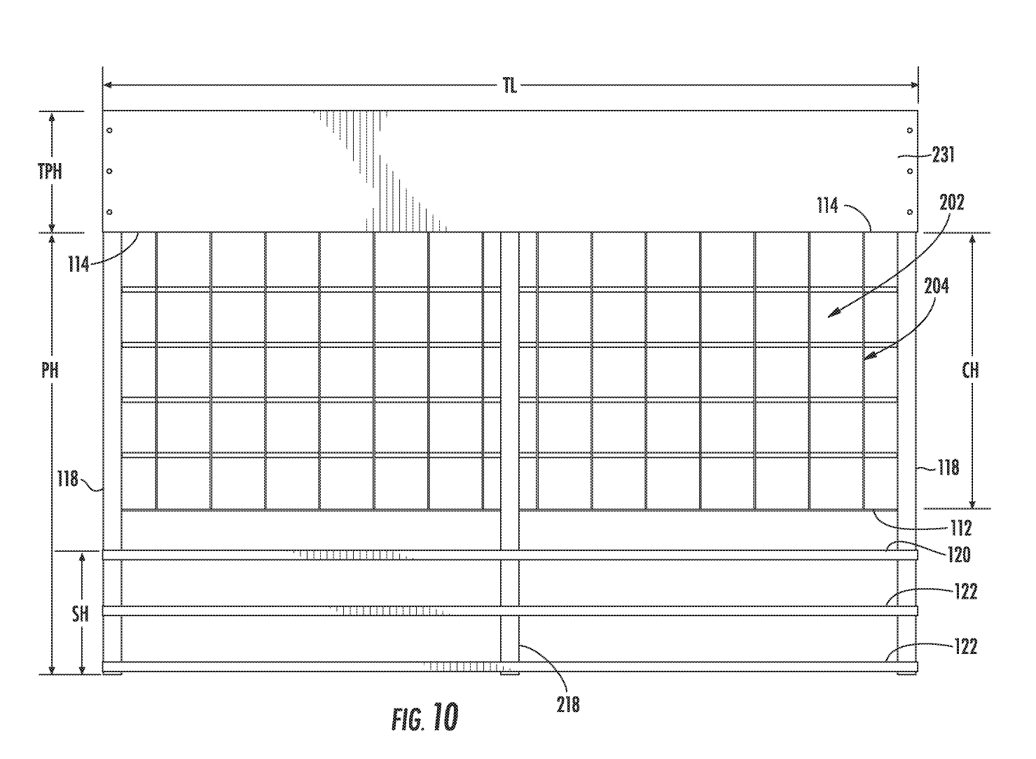

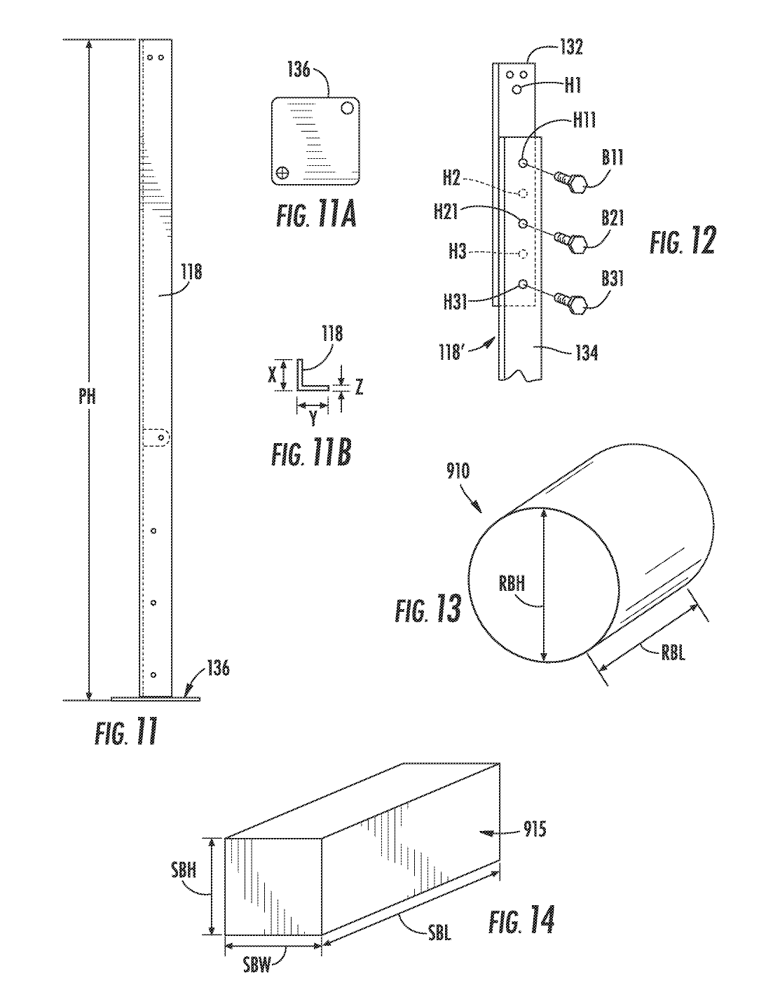

FIGS. 1 and 2 show the “square” feeder 100 is primarily for round (cylindrical) bales and can also be used for loose hay and smaller square or rectangular bales 915. In top view, it can be seen that this feeder 100 is actually square in overall shape with an inverted 4-sided pyramidal funnel type of hay cage 102. This shape pretty much self-aligns a round bale 910 dropped into it. The bottom tip of the pyramid is cut off to make a small square bottom opening 113 (e.g., 12″ square). A roughly 18″ high top panel 130 of sheet metal surrounds the top to help contain a large bale when it is first loaded. It can be reinforced with framing. A stabilizer 146 (feeder leg support) angles between the leg 118 and the nearest pyramid edge 116 of the cage 102. The skirt (lower panel) 124 is like the top panel 130 except that it may have only a top bar (skirt rail 120) for reinforcement, plus the frame 140 of the catch tray 138 (floor) that is attached as a second horizontal bar about midway down the panel/skirt.

It should be understood that the manger 138 or “feeder floor frame” 140 supports a full-sized (e.g., 75″×75″) tray of expanded metal 142 (or perforated sheet metal or woven screen or any planer material that will catch and hold hay pieces but allow water to pass through rather than accumulate).

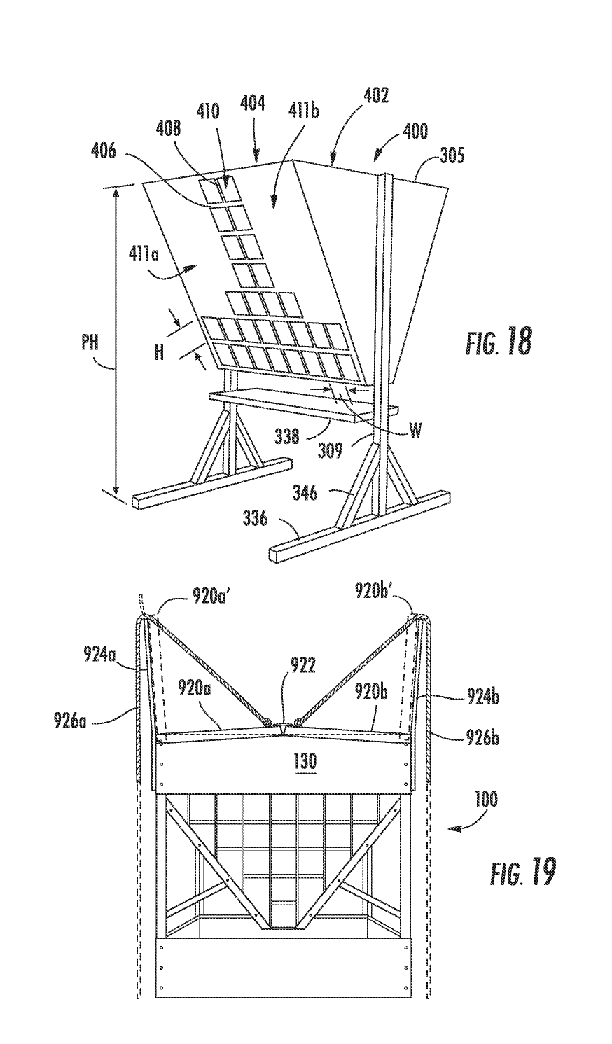

In FIGS. 17 and 18 the small animal feeders 300, 400 have a smaller version of the manger 338, which can also have a perforated floor 342 with a smooth top surface 344.

The “rectangular” feeder 200 (FIG. 3) is mostly the same as the “square” feeder 100 in the significant dimensions of height and gridwork opening size, although it is a bit taller to accommodate the larger bale size. The bottom skirt may be made of bars 120, 122 rather than sheet metal for cost reduction reasons. The biggest difference is that the top view is a rectangle (e.g., 120″ by 75″) and the hay cage 202 is an elongated V-shaped trough with two slanted rectangular gridwork sides 204 plus two vertical blank end panels 205 (e.g., sheet metal, cut in a triangular shape to match the funnel pattern of the hay cage). Thus the animals can only feed from the two long sides and not the ends. This enables lining up multiple hay feeders end to end. It also enables the rectangular-box shaped “square” bales 915 to stack up against the ends neatly.

Furthermore, the triangular trough shape enables stacking multiple large rectangular (3′×4′×8′) bales 915 in the hay feeder 200. In fact, two of the big bales can be easily dropped down in and they will self-align along the gridwork sides. When extra bales are laid on top, contained by the top panels, they add weight to press the hay down for a long lasting continuous supply of hay being presented at the hay cage gridwork openings 110 along the grid sides 204 (see FIG. 5). There is enough clearance on the ends to make this easy since the trough is preferably 10 feet long for 8 foot long bales.

The bottom of the triangular trough is truncated to about a 12″ wide opening. Extra support legs 209 may be added under the bottom of the cage 202 for reinforcement under the weight of the large bales. Likewise tie bars 213 can be added across the bottom opening 253 to prevent spreading apart in the middle of the length TL. Preferably an extra middle post 218 is used to support the middle of the length TL of the cage top 114.

Another advantage of the modular design is that a farmer having a still-usable prior art support frame (e.g., a circle of vertical cattle separator posts) can buy just the standard pyramidal hay cage 102 and mount it on top of his support frame. If desired, he could add the top panels 130 and/or short corner posts that would hook over the top ring of the support frame. Of course this is not a very satisfactory feeder, since the base is still much weaker than the materials being used in our products (prior art used 18 gauge steel tubing), and also the upward extending cattle separator bars interfere, especially with longhorn cattle, and cattle fighting for eating space can injure each other. Our feeder doesn't have separator bars, just corner posts 118 (or a center post 218) which leave around 6 feet of room on each side between posts 118, 218. Cattle will still jostle for position, but aren't trapped between separator bars. Also the corner posts 118 provide a reasonable limit for movement “around” the feeder 100.

How this very unique feeder design came about: I had a design on paper worked out then we worked to put it into practice, make it build-able.

The slope angle A1, A2 (about 52 degrees) is not a primary dimension, but rather is a result of matching other dimensions in our effort to create a feeder that would be accessible from all sides equally. Changing any dimension including the angles would change the overall dimensions and shape which would render a less ergonomic, useful, and smoothly transitioning feeder. It just all works seamlessly, smoothly, no sharp jutting components, four smooth corners, no accidents waiting to happen.

Referring especially to FIG. 15, The 32″ depth D measured from the outside of the lower panel (“skirt”) 124 straight across to the hay cage 102 is very important for ergonomic reasons, i.e., so that the animals can reach the hay when their chest (brisket) is up against the top skirt rail 120 and the skirt 124 (if present). Therefor the depth D should be about the same as an average brisket-to-muzzle distance BM. Since the bottom edge 112 of the grid/cage is about at the height of the skirt rail 120, the depth D is pretty much measured straight across to the bottom edge 112.

The height of the top skirt rail 120 (the skirt height SH) is also very important for the same ergonomic reason. Therefore the optimum skirt height SH is about equal to an average toe-to-brisket distance TB. If too high, then the animal cannot approach as closely to the feeder 100 sides.

Also referring to FIG. 7, the feeder 100 overall height (post height PH+top panel height TPH) is critical because farm tractors need to be able to raise a large, heavy bale high enough to roll it over the top and into the hay cage 102. Since even 60 year old tractors can lift that much weight 6.5 feet without too much trouble, that is generally used as a maximum overall height for the feeders 100, 200.

The feeder top opening dimensions (top length TL by top width TW) are selected to allow easy loading of a wide range of sizes of common round bales 910, for the square feeder 100 design (see one in place in FIG. 15). The rectangular feeder 200 is designed to handle the very large “square” bales 915 which can be dropped in lengthwise and two or three piled side by side in the V shaped cage 202 (see FIG. 5, where the end panel 205 and upper short panel 230 are illustrated as if they were transparent).

The bottom of the pyramid shaped cage 102 is truncated to yield a 12″ square bottom opening 113. Similarly, the bottom of the V shaped cage 202 is truncated to yield a 12″ wide bottom opening 253. This allows free sliding of the hay as the integrity of the bale breaks up, and also is important to prevent clogging as the bale is depleted. The animals can pick up all the “fines” that fall out of the funnel-like openings 113, 253 at the end of the bale. We advocate that the farmer not replace the bale until the animals clean up all the fines and dropped hay from the last bale. This works to reduce the buildup of hay, further reducing waste.

Referring to FIGS. 17 and 18, small animal 934 muzzle width MW and muzzle height

MH were measured as follows. All were about the same for MW and MH, so an average of both was approximated.

1) mini-horse 3.875″ (inches), (range of 3.0-4.75 inches)

2) alpaca 2.5″

3) Deer (Whitetail) 2.5″

4) calf (beef and dairy) 3.5″

5) goats 3.0″

For these muzzle dimensions, a square grid opening 310 having width W=Height H=5″ was tested. This is 1″ to 2.5″ over the muzzle dimensions, but the small animals are more delicate eaters so it turned out not to be a problem. So both our “Small Animal Feeder” 300 and our “Deer and Elk Feeder” 400 are made with W×H (opening width by height) size of 5″×5″ (inside measurement) openings 310, 410, respectively in the grid 304, 404, respectively. There is a feeder height PH difference on our deer and elk feeders 400. The Deer feeder 400 has a height PH of five feet, and the Elk feeder 400 has a height PH of six feet. I have recommended the six foot height PH for Alpaca feeders 300 as well.

The small animal feeder 300 can be smaller, but is still sturdy construction, using heavy gauge steel parts, as detailed elsewhere.

A recent innovation in making the grids 304, 404 for small animals 934 is illustrated in FIGS. 17 and 18. Instead of welding strips of steel together at every crossing point, a single sheet of steel is laser cut to make all the openings. Although there is a lot of scrap, there is a huge labor savings, and the result is smooth edged openings 310, 410 and a smooth sliding surface for the hay.

The deer feeder 400 is a variation we worked out based on input from the “Big” Deer and Elk breeder outfits. Their concern is the antlers which are extremely valuable, but can be damaged easily especially when soft while growing. So a novel grid 404 for the cage 402 has the grid openings 410 blanked off (not created) in the upper left and upper right portions 411a, 411b respectively, where antlers will touch when the animal is feeding from the middle or lower portion of the grid 404. This prevents the antlers from being caught in a metal edged opening 410.

The extra stabilizing corner legs 318 shown in dashed outline in FIG. 17 attached to the top of the feeder 300 are optionally used to make our “No-Tip Design” small animal feeder 300. Although they could be used for the deer feeder 400, we discovered that it is better not to because they create a trap for deer and elk antlers. Therefor, the alternative shown in both FIGS. 17 and 18 is an inverted T shape, with the foot plate 336 being extended as far as necessary to prevent tip-over. The vertical post 309 is stabilized by struts 346 near the bottom.

Examples of materials used and typical dimensions follow.

We use square tube on the legs 309, 346, 336, 318 of the small animal feeders 300, 400 (small animals=mini-horses, deer, goats, sheep, calves, alpacas, etc.).

For horses, we don't use a skirt 124 or skirt rails 120, 122 so as to prevent leg injuries to fragile horse legs. They are not needed to protect dropped hay due to the way horses feed, the way they are built (horses have long necks and legs so the hay cage 104, 204 is all that is needed to pose a physical barrier to the dropped hay. We use PH=5 foot corner posts 118, for all horses but the draft horses, for which we use PH=6 foot posts. This puts the top edge 114 of the hay basket/cage 102 at the approximate height of the animal at the withers (top of back) so that creates a physical barrier to them stepping forward under that basket.

The 3×3×7 square bales used in the rectangular feeder 200 weigh upwards of 1200 pounds so these are very stout feeders if you can imagine two of these at a time being dropped into the feeder 200, one from each side, repeatedly for decades. This is what makes our products so attractive, they are built to last.

We use 3×3×¼ inch steel angle for the legs/posts 118 (FIGS. 11, 11B, 12), and ¼ inch steel for the plate metal (e.g., foot 136 in FIG. 11A) and strip steel used in the grids. For the skirts 124 and panels 130, 205, 230, 231 we use ⅛ inch steel sheet. Using 2×2×¼ inch for any square tube steel. The upper panels 130, 230, 231 are reinforced with angle iron supports 126 and rails 128 welded inside, to protect when loading. Similarly, the lower skirt panels 124 are also reinforced with angle iron rails 120, 122 inside. Also the lower skirts 124 have a detail (not shown) for preventing leg injuries. The upper edge of the skirt panel 124 is hemmed (folded and flattened in the brake press), then a J bend, with the angle iron top skirt rail 120 welded inside this. This is done to create a surface that will not scrape, cut any leg inadvertently placed inside, and offer a durable piece. This applies across the entire feeder line 100, 200, 300, 400, wherever a skirt might be used.

FIG. 1 shows an option of using reinforcement posts 126 and rails 128 on two sides of the top, only. However, testing shows that we need to reinforce all four of the upper panels 130, 230, 231.

In a future variation of the small animal designs like the Deer feeder 400, we are working on using black poly bunks (tubs), which will allow hay cages 402 to be larger, deeper, more durable, less expensive.

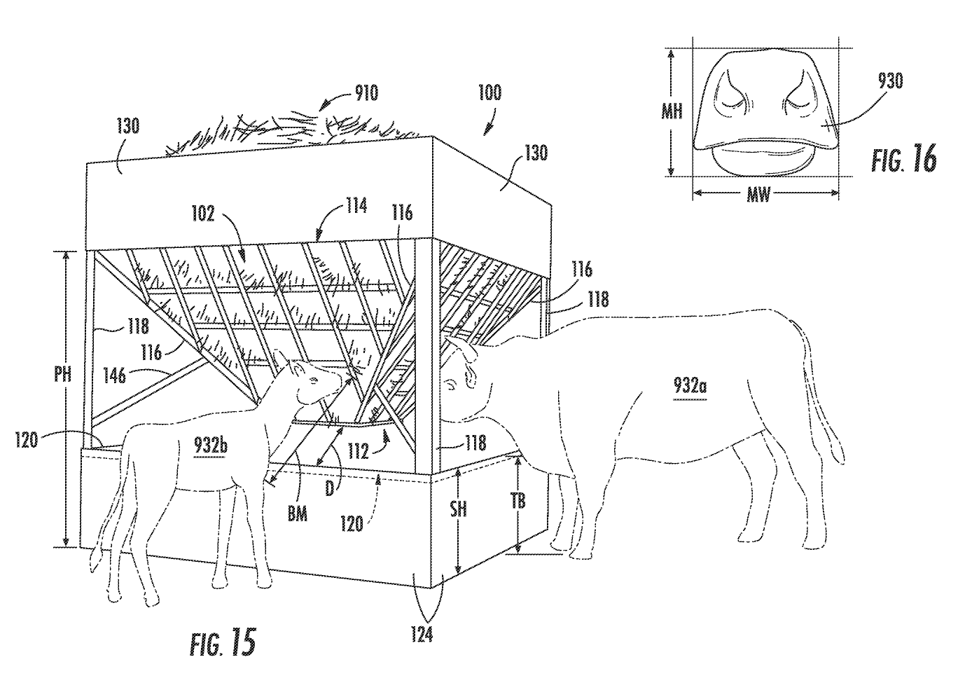

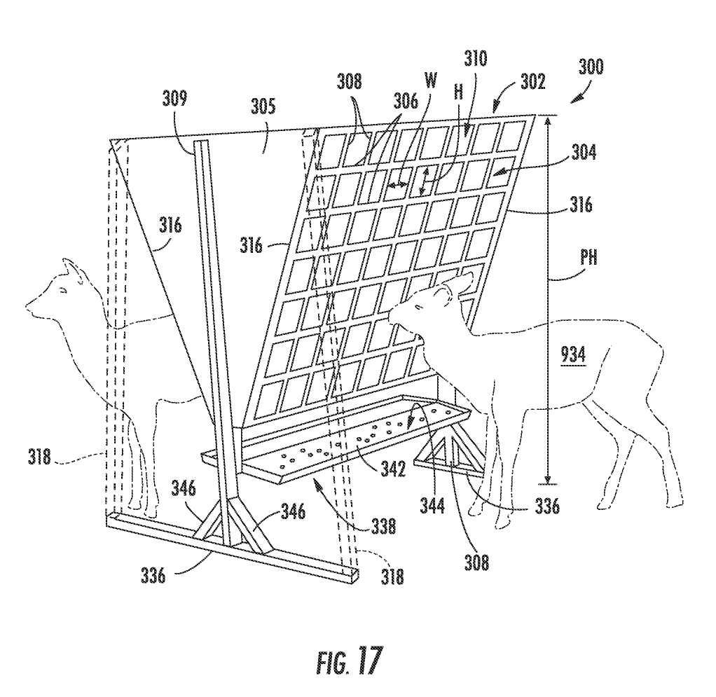

The deer feeder 400 and the small animal feeder 300 will hold three square bales 915 (the traditional square bale is a 40 to 80 pound bale, on average 18×18×42 inches for the SBH×SBW×SBL dimensions shown in FIG. 14).

As with the square feeder 100, the grid slope angle A2 on the rectangular feeder 200 is not as critical as the dimensions of overall height (post height PH+top panel height TPH), width TW and length TL of the top opening, and depth D skirt rail to cage, and skirt height SH to make sure they are ergonomic, accessible for the target animals, and easy to load. The angle A1, A2 of the hay cage sides must be enough to create a gravity feed arrangement. As the integrity of the bale breaks up as the animals feed, the hay will slide downward and fill any voids created. We take care in our designs to make sure we keep the interior as a “no-snag” surface so the bale will slide evenly and easily. For example, the heavy duty grids 104, 204 are made with horizontal bars 106 lying flat along the slope, but the vertical bars 108 are perpendicular which promotes vertical sliding as well as providing good strength to resist bending under load.

A “Fenceline” variation (not illustrated) has a blank plate in place of one of the grids 104, 204, 304, 404, which is useful for placing the feeder with the blank face against/along a fence to allow loading the hay without having to enter the animal enclosure.

FIG. 19 shows an available rain cover 920 on a square feeder 100. A sheet metal left trap door 920a and right trap door 920b are shown in a protective closed position. A strip of material 922 is attached on the left door 920a such that it covers the gap between doors. A left and right side post 924a and 924b are attached to the top panel 130 on each side, and extend up at an outward angle. A pull rope 926 goes over the side post and lifts the door halves to their raised position 920a′ and 920b′

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention as claimed are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A feeder of hay-like livestock feed including types of feed being provided as, or mixed in with one or more of straw, grass-like plant stems, grains and shafted grains; the feeder comprising:
a hay holding cage that has a gridwork of horizontal as well as vertical bars that create openings sized to limit livestock to pulling out only a mouthful of hay at a time, thereby reducing wasted hay dropped on the ground, wherein opening is 1 to 2.5 inches larger than muzzle dimensions for the animals to be fed,
a skirt rail at a height matching a toe to brisket dimension of cattle;
a top opening sized for length of bale, and bottom of grid spaced to get about 32″ from cage side to outside of top skirt rail=average brisket to muzzle/nose dimension for cattle
inverted pyramid-like funnel with four sides (gridwork on all 4 if square/equal-sided pyr); or (long rectangular cage is V trough with flat vertical ends covered by panels, and
four corner legs supporting top of cage.
